(19) United States
(12) Patent Application Publication
(10) Pub. No.: US 2026/0362456 A1
(43) Pub. Date: Nov. 12, 2026

(54) REQUIRING HIGHER SIGNAL QUALITY AT NEXT MULTI-AP COORDINATION (MAPC) ACCESS POINTS

(71) Applicant: Cisco Technology, Inc., San Jose, CA (US)

(72) Inventors: Brian D. Hart, Sunnyvale, CA (US); Malcolm M. Smith, Richardson, TX (US); Binita Gupta, San Diego, CA (US)

(21) Appl. No.: 19/410,565

(22) Filed: Dec. 5, 2025

Related U.S. Application Data
(60) Provisional application No. 63/800,540, filed on May 6, 2025.

(51) Int. Cl. H04W 72/27; H04L 1/00

(52) U.S. Cl. CPC H04W 72/27; H04L 1/0003

(57) ABSTRACT

Techniques are presented in which a first access point (AP) grants a portion of a transmit opportunity (TXOP) to a second AP when the second AP is in a sufficiently high-quality environment. The first AP, which engages in Multi-AP Coordination (MAPC) exchanges with the second AP, obtains a TXOP for accessing a channel to transmit frames. The first AP determines interference conditions associated with the second AP and grants a portion of the TXOP to the second AP based on the interference conditions associated with the second AP.

### CROSS REFERENCE TO RELATED APPLICATION

This application claims priority to U.S. Provisional Application No. 63/800,540, filed May 6, 2025, the entirety of which is incorporated herein by reference.

### TECHNICAL FIELD

The present disclosure relates to wireless networks.

### BACKGROUND

Next generation wireless local area networks, such as Wi-Fi®8 wireless local area networks, may use Multi-Access Point (AP) Coordination (MAPC) technologies in which multiple access points work together to improve performance, reduce interference, and optimize resource sharing. For example, a first AP may share a portion of its transmit opportunity (TXOP) with a second AP to improve efficiency and performance. However, the first AP may be some distance away from the second AP and the second AP may be in a very different interference environment than the first AP.

### BRIEF DESCRIPTION OF THE DRAWINGS

FIG. 1 is a diagram of a wireless network in which the techniques presented herein may be employed, according to an example embodiment.

FIG. 2 is a diagram of an exemplary network that has a frequency reuse factor of nine, according to an example embodiment.

FIG. 3 is a diagram illustrating an exemplary method of MAPC discovery, negotiation, and operation, according to an example embodiment.

FIG. 4 is a diagram illustrating a method of determining whether an AP is in a sufficiently good environment for having a portion of a TXOP granted to the AP, according to an example embodiment.

FIG. 5 is a diagram of a method of performing a two-hop carrier sense check to determine an interference quality at an AP, according to an example embodiment.

FIG. 6 is a flow chart of a method of having a portion of a TXOP granted to an access point based on a signal quality associated with the access point, according to an example embodiment.

FIG. 7 illustrates a hardware block diagram of a device that may perform the functions of access point in connection with the techniques presented herein.

### DESCRIPTION OF EXAMPLE EMBODIMENTS

### Overview

In one embodiment, a method is provided for having a portion of a transmit opportunity granted to an access point based on interference conditions associated with the access point. A first access point, which engages in Multi-AP Coordination (MAPC) exchanges with a second AP, may obtain a transmit opportunity (TXOP) for accessing a channel to transmit frames. The first AP may determine interference conditions associated with the second AP. The first AP may grant a portion of the TXOP to the second AP based on the interference conditions associated with the second AP.

### Example Embodiments

Next generation wireless local area networks, such as Wi-Fi®8 networks, may use one or more Multi-AP Coordination (MAPC) technologies, including technologies taken from a subset of the following: Coordinated Time Division Multiple Access (Co-TDMA), Coordinated Spatial Reuse (Co-SR), MAPCo-Service Periods (MACo-SPs), Coordinated Restricted Target Wake Time (Co-RTWT), Coordinated Orthogonal Frequency Division Multiple Access (Co-OFDMA), Coordinated Beam Forming (Co-BF), Joint Transmission (JT), etc.

An AP may be granted a transmit opportunity (TXOP) in which the AP is able to transmit traffic on a channel without channel contention for a (short) period of time. For Co-TDMA, a first AP holding a first TXOP may share a portion of the TXOP with a second AP. For example, the first AP may have additional transmission time in the TXOP, but may not have additional traffic to transmit or its traffic might be lower priority than the traffic of a neighboring AP. Therefore, to improve performance and optimize resources, the first AP may share a portion of, or the remainder of, the TXOP with the second AP. If the second AP does not need the entire time, the AP might return any unused portion of the TXOP back to the first AP.

The second AP may be some distance from the first AP (e.g., the square root of (FRF) Basic Service Set (BSS) diameters away, where FRF = frequency reuse factor) so that the interference/noise environment around the second AP might be very different than the interference/noise environment around the first AP. To ensure that the second AP is able to make good use of the portion (or remainder) of the shared TXOP, the first AP may identify a signal/interference/noise quality at the second AP and/or at the clients of the second AP before sharing the portion of the TXOP with the second AP. A Multi-User Request-to-Send (or simply Request-to-Send) and Clear-to-Send [(MU)RTS+CTS] exchange sent at a low modulation coding scheme (MCS) level, such as MCS0, merely verifies that the Signal-to Interference-plus-Noise Ratio (SINR) is above a low threshold, such as 5 dB, at the second AP. This may not be enough to ensure that the environmental interference/noise quality at the second AP is high enough to make effective use of the remainder of the TXOP. The interference level at the first and second APs typically changes over the scale of 0.1 to 5 milliseconds as 802.11 transmissions by nearby devices start and stop; and related time scales arise from the transmissions of non-802.11 devices if present.

Presented herein are techniques in which the first AP may identify interference conditions associated with an environment of a second AP and grant a portion (or remainder) of a TXOP to the second AP if the second AP is in a sufficiently good interference or noise quality environment. If the second AP is not in a sufficiently good interference/noise environment, the first AP may not grant a portion of the TXOP to the second AP and/or may grant the portion of the TXOP to another AP that is in a better interference/noise environment. The first AP may determine the interference conditions associated with the second AP in a number of different ways.

According to some embodiment, to ensure that the second AP is in a sufficiently good interference environment, the first AP may negotiate, in relation to transmissions between the first and second APs, a minimum signal-to-interference-plus-noise ratio (SINR) or a maximum received Error Vector Magnitude (EVM) or a minimum 1/(I+N) level, where I is interference and N is noise. In other embodiments, the first AP may negotiate a maximum noise + interference level, or a different maximum noise and/or interference level. In these embodiments, the first AP may send a message to the second AP and, if the signal quality is insufficient (or the interference level is too high) at the second AP based on the negotiated level, then the second AP may send a Negative-Acknowledgement (NAK) frame or no response frame.

According to another embodiment, during broadcast policy advertising (e.g., in a beacon) negotiations with other APs, the first AP may report that it will always send (or be able to send) an Initial Control Frame (ICF) for MAPCo-related exchanges at a high MCS level. In other embodiments, the first AP may follow the policy without advertising the policy. In these embodiments, the first AP may decline AP-to-AP (AP2AP) MAPC requests and/or reject negotiated AP2AP MAPC agreements if or when the higher MCS level cannot be routinely achieved between itself and a peer AP (either when initiated by the first AP and/or the second AP, such as part of the TXOP used to begin AP2AP negotiations). As well, the allocation by a first AP to a peer AP may automatically fail if the peer AP is unable or rarely able to receive an initial control frame (ICF) sent at the high MCS. In this situation, the MAPC agreement might not be declined or rejected, but no or few allocations may be made by the first AP to a peer AP. Similarly, if an AP always uses a higher MCS for MAPC discovery and/or MAPC negotiation, no MAPC agreements with a peer AP at a lower signal quality might be established.

According to yet another embodiment, to ensure that the environmental quality at the second AP is sufficiently high (and the interference is sufficiently low), the first AP may negotiate that the second AP perform a two-hop carrier sense check that fulfills one or more quality requirements. The two-hop carrier sense check may include sending a message from the first AP to the second AP, sending a second message from the second AP to one or more clients in a basic service set (BSS) associated with the second AP, receiving a third message at the second AP from the one or more clients, and sending a fourth message from the second AP to the first AP. In some embodiments, the environmental quality/interference levels at different hops may be determined using different metrics.

Thus, present embodiments improve the technical field of wireless networks by ensuring that an AP is in a sufficiently good interference environment before a portion of a transmit opportunity is granted to the AP. Present embodiments therefore increase the efficiency of wireless network transmission by granting portions of transmit opportunities to access points that are in a sufficiently good interference environment to make use of the transmit opportunity. In addition, the present embodiments increase the efficiency of communications in the wireless networks by ensuring that portions of transmit opportunities are not wasted by access points in high noise or interference environments that are unable to fully use the transmit opportunities. Thus, present embodiments provide the practical application of determining that an access point is in a sufficiently low interference environment prior to having a portion of a transmit opportunity granted to the access point to ensure that the access point will be able to make use of the transmit opportunity and resources can be shared.

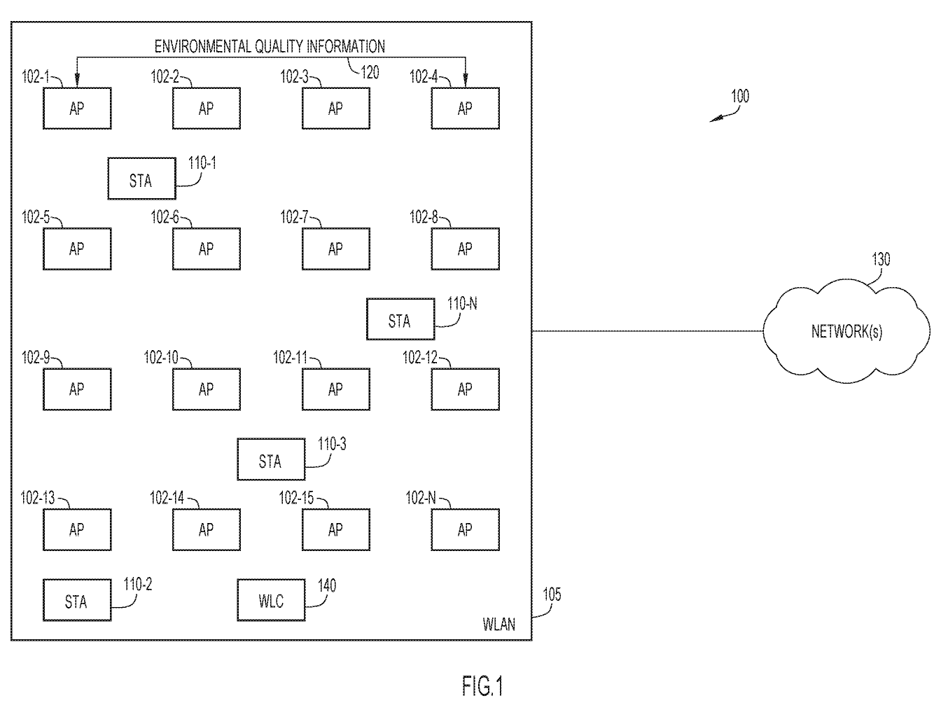

Reference is now made to FIG. 1. FIG. 1 is a block diagram of an environment 100 according to an example embodiment. In at least one embodiment, the environment 100 may include network(s) 130 and a wireless local area network (WLAN) 105 that includes a plurality of access points (APs) 102-1, 102-2, 102-3, 102-4, 102-5, 102-6, 102-7, 102-8, 102-9, 102-10, 102-11, 102-12, 102-13, 102-14, 102-15, …, 102-N that serve stations (STAs) 110-1, 110-2, 110-3, …, 110-N, which are also known as wireless clients or user equipment (UEs). APs 102-1 to 102-N may provide wireless Radio Frequency (RF) coverage to STAs 110-1 to 110-N to allow STAs 110-1 to 110-N to communicate with one another or to access resources on another network or networks, such as network(s) 130.

In the example illustrated in FIG. 1, each of the APs 102-1 to 102-N are configured for Multi-AP Coordination (MAPC), and can engage in MAPC exchanges. For example, a first AP, AP 102-1, can engage in MAPC exchanges with a second AP, AP 102-4, as described below. WLAN controller (WLC) 140 may be involved in facilitating the techniques described herein, such as by coordinating MAPC exchanges.

In a typical WLAN, such as WLAN 105, adjacent APs, such as AP 102-1 and AP 102-2, may not transmit and receive data on the same channel. The frequency reuse factor of the network is a measure of how often a frequency is reused within a system. Based on the frequency reuse factor, every Nth AP may share the same frequency. The distance between APs that share the same frequency may be based on the square root of the frequency reuse factor, or thereabouts and, for instance, might be described by a distribution which tends to be centered at approximately the square root of the frequency reuse factor. MAPC may occur among one or more pairs of nearby co-channel APs. For example, APs that share the same frequency may share portions of transmit opportunities.

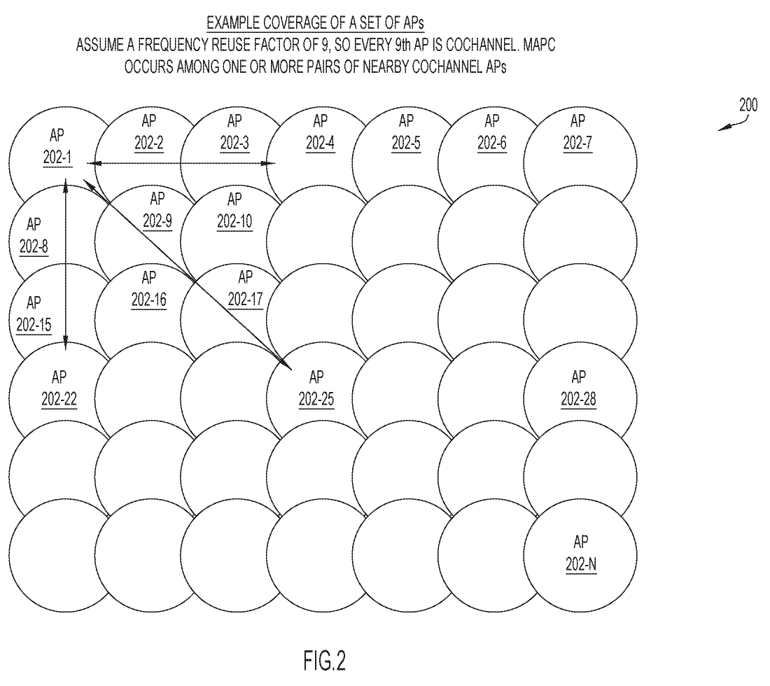

Reference is now made to FIG. 2. FIG. 2 is a diagram of a network 200 that has a frequency reuse factor of nine. This diagram is idealized for ease of exposition since in practice regular deployments of APs are hard to achieve, RF propagation is variable, there might be APs on floors above or below, etc. Network 200 includes APs 202-1 to 202-N. Only some of the APs (i.e., AP 202-1, AP 202-1, AP 202-3, AP 202-4, AP 202-5, AP 202-6, AP 202-7, AP 202-8, 202-9, AP 202-10, AP 202-15, AP 202-16, AP 202-17, AP 202-22, AP 202-25, AP 202-28, and AP 202-N) in FIG. 2 have been labeled for the sake of simplicity.

The frequency reuse factor of network 200 is nine and the square root of nine is three. Therefore, in a square of nine APs, with three APs across and three APs down, each AP in this idealized network will use a different channel. Starting with AP 202-1, each AP in the 3 AP x 3AP square will use a different channel. In this example, AP 202-1, AP 202-2, AP 202-3, AP 202-8, AP 202-9, AP 202-10, AP 202-15, AP 202-16, and AP 202-17 will each use different channels. In the example illustrated in FIG. 2, assume AP 202-1 uses channel A. The next closest APs that use channel A in this example are AP 202-4, AP 202-22, and AP 202-25. AP 202-4, AP 202-22, and AP 202-25 are in 3 AP x 3 AP squares adjacent the 3 AP x 3 AP square associated with AP 202-1.

In this example, AP 202-1, AP 202-4, AP 202-22, and AP 202-25 are co-channel APs. Therefore, some or all of AP 202-1, AP 202-4, AP 202-22, and AP 202-25 may participate in MAPC by, for example, sharing portions of transmit opportunities. Fewer than all APs might be involved in a TXOP for multiple reasons, such as one AP being out of RF range of the TXOP holding AP. Because AP 202-1, AP 202-4, AP 202-22, and AP 202-25 are some distance away from each other, the environmental quality may vary in the different environments surrounding each AP. For example, the interference or noise around AP 202-1 may be different from the interference around AP 202-4. If an AP, such as AP 202-1, were to share a portion of a TXOP with AP 202-4, and AP 202-4 was in a noisy environment, AP 202-4 may not be able to use the portion of the transmit opportunity. Therefore, it is beneficial to ensure that an AP is in a sufficiently high quality (i.e., low interference level) environment before granting a portion of a TXOP to the AP.

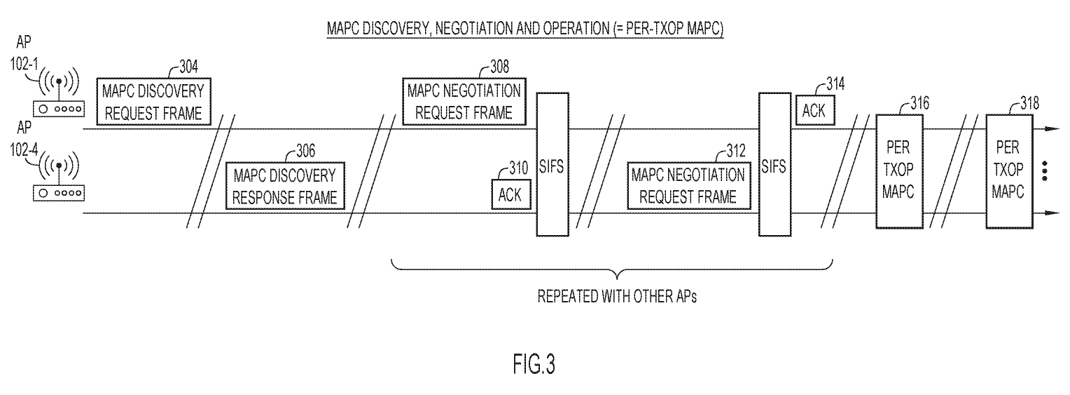

Returning to FIG. 1, assume that AP 102-1 and AP 102-4 are co-channel APs that use the same or partially overlapped channel for transmission. AP 102-1 may have obtained a transmission opportunity during which AP 102-1 can transmit a series of frames without recontending for a time slot. AP 102-4 may have indicated that it has data to transmit, and AP 102-1 may have a portion of the TXOP that it can share with AP 102-4 to transmit the data. AP 102-1 and AP 102-4 may have previously performed a negotiation to coordinate the sharing of transmission opportunities. AP 102-1 may have additionally performed negotiations with other co-channel APs to coordinate sharing of transmission opportunities, as described below with respect to FIG. 3.

Reference is now made to FIG. 3. FIG. 3 is a diagram illustrating a method of MAPC discovery, negotiation, and operation. The MAPC discovery and negotiation may enable MAPC across many subsequent TXOPs, and MAPC operation may occur in TXOPs on a selection of, a majority of, or all TXOPs. In the example illustrated in FIG. 3, the discovery, negotiation, and operation may occur between AP 102-1 and AP 102-4.

AP 102-1 may transmit (e.g., broadcast) a MAPC discovery request frame 304 to make itself discoverable by co-channel APs. The MAPC discovery request frame 304 may be similar to a beacon, but the MAPC discovery request frame 304 may be intended for other APs and not for clients. AP 102-1 may transmit the MAPC discovery request frame 304 to discover other APs with whom to coordinate. AP 102-4 may receive the MAPC discovery request frame 304 and respond with a MAPC discovery response frame 306 indicating that AP 102-4 received the MAPC discovery request frame 304 and AP 102-4 is interested in participating in MAPC with AP 102-1.

After AP 102-1 has discovered AP 102-4, AP 102-1 may initiate negotiations by transmitting MAPC negotiation request frame 308. MAPC negotiation request frame 308 may include parameters or conditions for the MAPC partnership. For example, MAPC negotiation request frame 308 may indicate a level of signal quality to be achieved by AP 102-4 for MAPC operation during the partnership. For example, interference levels at AP 102-4 may vary and AP 102-4 may request a portion of the TXOP during periods of time in which the interference levels are low enough (e.g., below a threshold level). In some embodiments, MAPC negotiation request frame 308 may indicate a minimum SINR (e.g., 15 dB, 25 dB, 35 dB, etc.) or a maximum error vector magnitude (EVM) (e.g., -30 dB, -35 dB, etc.) corresponding to communications with AP 102-1 and/or with clients associated with AP 102-4 as a condition for performing MAPC functions with AP 102-1, such as a MAPC allocation during a TXOP. In another embodiment, the MAPC negotiation request frame 308 may indicate that AP 102-1 will send (or be able to send) an initial control frame (ICF) for MAPCo-related exchanges at a high MCS level, such as 24 megabits per second (Mbps) or 36 Mbps. AP 102-4 may respond with an acknowledgement 310 acknowledging receipt of the MAPC negotiation request frame 308.

After a Short Interframe Space (SIF), AP 102-4 acknowledges a received MAPC negotiation request frame. Next, AP 102-4 processes the received MAPC negotiation request frame 308, then AP 102-4 may respond with MAPC negotiation response frame 312 indicating parameters and/or conditions for the MAPC partnership. AP 102-1 may transmit acknowledgement 314 indicating receipt of the MAPC negotiation response frame 312. AP 102-1 may additionally send the MAPC negotiation request frame 308 to other APs that were discovered based on broadcasting the MAPC discovery request frame 304 and/or receiving MAPC discovery request or response frames and, in response, AP 102-1 may receive MAPC negotiation response frames from the other APs.

When AP 102-1 is granted a TXOP, AP 102-1 may determine to share a portion of the TXOP with AP 102-4 (and vice versa). For example, there may be additional time in the TXOP and AP 102-1 may not have additional traffic to submit, or its traffic priority may be lower than the priority of AP 102-4’s traffic. It is beneficial to share the portion of the TXOP with an AP that is in a sufficiently high quality/low interference level environment to make use of the portion of the TXOP. At 316 and 318, AP 102-1 may determine whether AP 102-4 is in a sufficiently good interference or noise environment and may grant a portion of the TXOP to AP 102-4 if AP 102-4 is in a high-quality environment (e.g., if no device close to AP 102-4 is transmitting/emitting that interferes with the operations of AP 102-4).

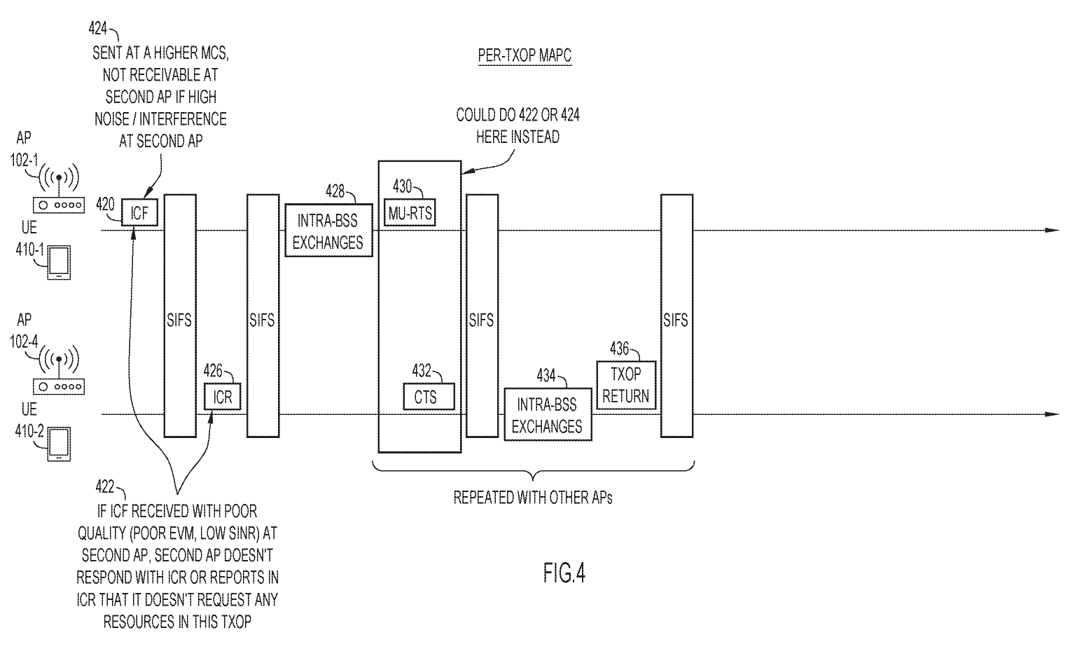

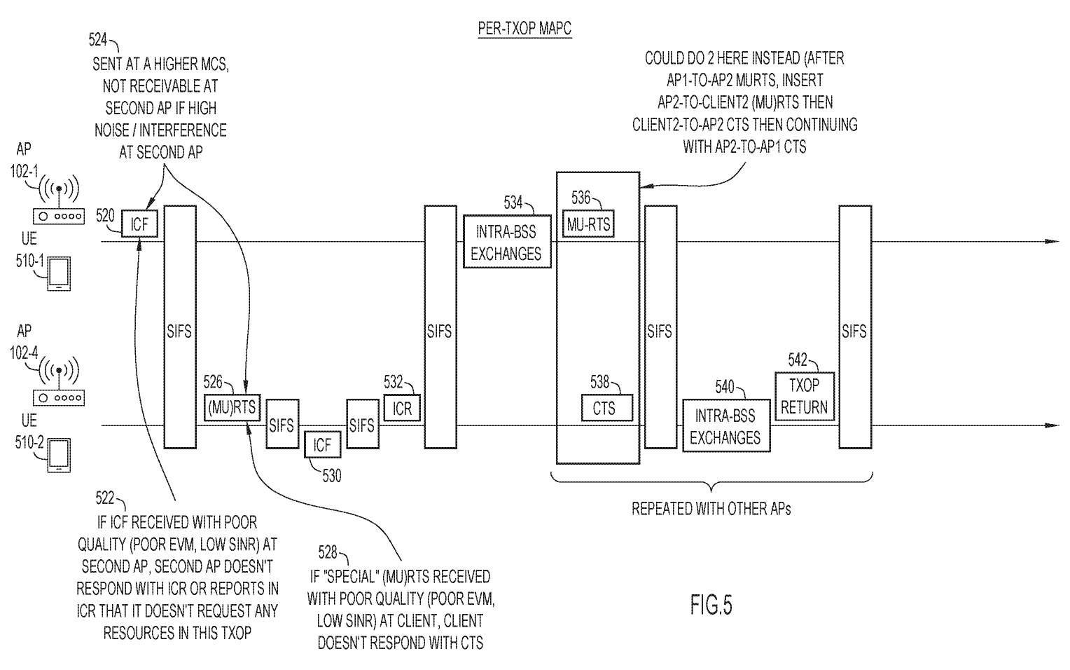

Returning to FIG. 1, and as described in detail with respect to FIGS. 4 and 5, AP 102-1 may obtain a TXOP and may determine that it has additional transmission time after transmitting data. At the start of the TXOP or later in the TXOP, AP 102-1 may reach out to co-channel APs, such as AP 102-4 and possibly other APs, to determine whether the co-channel APs have traffic to transmit. If AP 102-4 responds that it has traffic to transmit on the channel, possibly after comparing the priority and/or urgency of the AP 102-4’s traffic with respect to its own traffic and other peer APs’ traffic, AP 102-1 may grant a portion or a remainder of the TXOP to AP 102-4. However, if AP 102-4 is in a high interference or noise environment, the TXOP may be wasted. Therefore, prior to granting the portion of the TXOP to AP 102-4, AP 102-1 may first verify that AP 102-4 is in a sufficiently good interference/noise environment to make use of the transmission opportunity. As illustrated in FIG. 1, at 120, AP 102-1 and AP 102-4 may exchange messages so that AP 102-1 is able to gather information indicating an interference/noise/environmental quality associated with AP 102-4 (or clients in the BSS associated with AP 102-4) prior to granting the portion of the TXOP.

As further discussed below with respect to FIGS. 4 and 5, AP 102-1 may gather environmental quality information in a number of ways. In one embodiment, AP 102-1 may determine whether the SINR or EVM associated with AP 102-4 is sufficiently good based on sending an inquiry, such an AP Queue Report Poll (AQRP)-like inquiry or handover or initial control frame, to AP 102-4. In another embodiment, AP 102-1 may determine that AP 102-4 is in a sufficiently good interference or noise environment if AP 102-4 is able to receive messages, such as ICFs, at a relatively high MCS rate (e.g., 24 Mbps). In one example, the MCS rate may have been advertised during broadcast policy advertising negotiations, such as in MAPC negotiation request frame 308 of FIG. 3. In yet another embodiment, AP 102-1 may determine that AP 102-4 is in a sufficiently good interference or noise environment based on AP 102-4 monitoring its interference or noise level immediately before or after the ICF and/or performing a two-hop carrier sense check in which AP 102-4 exchanges messages with AP 102-1 and with one or more clients in the BSS associated with AP 102-4, whereby the following response from AP 102-4 to AP 102-1 (or the absence of such a response) assists this determination.

If AP 102-4 is in a sufficiently good interference/noise environment, AP 102-1 may allocate a portion or a remainder of the TXOP to AP 102-4. If AP 102-4 is not in a sufficiently good interference/noise environment, AP 102-1 may not allocate a portion of the TXOP to AP 102-4. In this case, AP 102-1 may allocate the portion of the TXOP to another co-channel AP that is in a better interference/noise environment or end its TXOP early so that any other STA (or device) can contend for the medium time earlier.

Reference is now made to FIG. 4. FIG. 4 is a diagram illustrating a method of determining whether an AP is in a sufficiently good interference/noise environment for granting a portion of a TXOP to the AP. The method of FIG. 4 may be performed, at least in part, by AP 102-1, and AP 102-4, in order to provide improved service to UE 410-1 and UE 410-2. UE 410-1 may be in a BSS associated with AP 102-1 and UE 410-2 may be in a BSS with AP 102-4.

In the example illustrated in FIG. 4, AP 102-1 may have obtained a TXOP and may determine whether to grant an unused portion/remainder of the TXOP to AP 102-4. In one embodiment, AP 102-4 may have indicated that it has traffic to transmit, via indication of ongoing periodic traffic or specific traffic in the ICR (or a recent ICR). AP 102-1 may first determine whether AP 102-4 is in a sufficiently good environment to make use of the portion of the TXOP. AP 102-1 and AP 102-4 may have previously performed some or all of the MAPC discovery and negotiation steps, and zero or more operation steps discussed with respect to FIG. 3.

AP 102-1 may transmit initial control frame (ICF) 420 to AP 102-4. In some embodiments, AP 102-1 may transmit an AQRP-like inquiry or handover frame to AP 102-4. In a first embodiment, AP 102-1 may have negotiated a threshold quality indicating whether AP 102-4 is in a sufficiently good signal, interference and/or noise environment to be granted a portion of a TXOP. AP 102-1 may have indicated the threshold quality, for example, in MAPC negotiation request frame 308. In one embodiment, the threshold quality may be expressed as, for example, a minimum SINR, maximum received EVM or minimum 1/(I+N) level, where I is interference and N is noise. The level may be encoded, for example, as a magnitude or power expressed in watts, dB, dBm, dBW, etc. In another embodiment, the threshold quality may be a maximum noise + interference level that may be expressed as, for example, a magnitude or power expressed in watts, dB, dBm, dBW, etc. The threshold quality may be another level that indicates an interference, noise, and/or signal quality associated with an environment. The threshold signal quality may be, for example, a minimum SINR of 15 dB, 25 dB, 35 dB, etc., or a maximum EVM of -30 dB or -35 dB. Hereafter, the terms signal/environmental quality below a threshold, poor EVM, low SINR, high interference and the like encompass all the variants in this paragraph.

AP 102-4 may respond to ICF 420 with an initial control response frame (ICR) 426. In one embodiment, as illustrated at 422, if the ICF 420 is received at AP 102-4 with poor quality (e.g., the signal quality is below the threshold level, with poor EVM, a low SINR, etc.) or the interference and/or noise immediately before or after the ICF is poor (e.g., (N+I) above a threshold), ICR 426 may include an indication that the environmental quality is low and/or that AP 102-4 does not request any resources in the TXOP. In another embodiment, if the signal quality is insufficient (or the interference level is too high), AP 102-4 may send a NAK frame to AP 102-1. In another embodiment, if the signal quality is low/interference level is high, AP 102-4 may not respond with ICR 426 or send any response at all. In these embodiments (i.e., AP 102-1 receives ICR 426 or NAK frame indicating a poor signal quality (or no resources requested such as due to poor signal quality), or AP 102-1 does not receive a response frame), AP 102-1 may not grant the portion of the TXOP to AP 102-4.

In a second embodiment, AP 102-1 may have broadcasted a policy during negotiations with APs (e.g., in MAPC negotiation request frame 308) that AP 102-1 will send (or be able to send) an ICF for MAP-related exchanges at a relatively high MCS level (e.g., 24 Mbps or 36 Mbps). In some embodiments, AP 102-1 may follow the policy of sending MAP-related exchanges at a higher MCS level without advertising the policy. As illustrated at 424, AP 102-1 may transmit ICF 420 to AP 102-4 at the higher MCS level. If AP 102-4 is unable to receive the ICF 420 (e.g., due to high noise and/or interference), AP 102-1 may determine that AP 102-4 is in a poor interference/noise quality environment and AP 102-1 may not grant the portion of the TXOP to AP 102-4.

In some embodiments, if AP 102-4 is unable to routinely achieve the higher MCS level, AP 102-1 may decline AP-to-AP (AP2AP) MAPC requests from AP 102-4. In other embodiments, if AP 102-1 and AP 102-4 have negotiated AP2AP MAPC agreements (either when initiated by the AP 102-1 and/or AP 102-4, such as part of the TXOP used to begin AP2AP negotiations), but AP 102-4 is unable to routinely achieve the higher MCS level, then AP 102-1 may reject the agreement established between the two APs. In addition, the allocation by AP 102-1 to AP 102-4 may automatically fail if AP 102-4 is unable or rarely able to receive an ICF sent at the high MCS. In this case, the MAPC agreement might not be declined or rejected, but no or few allocations may be made by AP 102-1 to AP 102-4. Similarly, if an AP always uses a higher MCS for MAPC discovery and/or MAPC negotiation, no MAPC agreements with a peer AP at a lower signal quality might be established.

If AP 102-1 determines that the interference level at AP 102-4 is sufficiently low (e.g., by using one of the methods described in conjunction with 422 or 424), AP 102-1 may determine to grant a portion of the TXOP to AP 102-4. In this case, at 428, AP 102-1 may perform intra-BSS exchanges with UE 410-1 (and possibly other UEs in the BSS) to transmit traffic during a first portion of the TXOP. When AP 102-1 has completed transmitting some or all of this traffic, AP 102-1 may transmit a Multi-User Request-to-Send (MU-RTS) frame 430 to allocate an unused portion or remainder of the TXOP. AP 102-4 may respond with a Clear to Send (CTS) frame 432. In some embodiments, instead of determining the environmental quality at AP 102-4 using ICF 420, ICR 426, and the methods described with respect to 422 and 424, AP 102-1 may perform the methods described with respect to 422 and 424 using MU-RTS frame 430 and CTS frame 432 to determine the environmental quality at AP 102-4.

At 434, AP 102-4 may perform intra-BSS exchanges with UE 410-2 (and possibly other UEs in the BSS) using the unused portion of the TXOP granted by AP 102-1. When the transmission of traffic to UE 410-2 is completed, AP 102-4 may transmit TXOP return frame 436 to return the remainder of the transmission opportunity back to the sharing AP, AP 102-1. In some cases, the steps described with respect to MU-RTS frame 430, CTS frame 432, intra-BSS exchanges 434, and TXOP return frame 436 may be repeated with other APs that have requested a portion of the TXOP and who are in a sufficiently low interference level environment.

Reference is now made to FIG. 5. FIG. 5 is a diagram of a method of performing a two-hop carrier sense check to determine an environmental quality (e.g., interference level) at an AP. The method of FIG. 5 may be performed, at least in part, by AP 102-1, UE 510-1, AP 102-4, and UE 510-2. UE 510-1 may be in a BSS associated with AP 102-1, and UE 510-2 may be in a BSS with AP 102-4.

In the example illustrated in FIG. 5, to determine an environmental quality at AP 102-4 (e.g., prior to granting a portion of a TXOP to AP 102-4), AP 102-1 may negotiate that AP 102-4 perform a two-hop carrier sense check. As described in FIG. 5, the two-hop carrier sense check may include, for example, transmitting an ICF from AP 102-1 to AP 102-4, transmitting, by AP 102-4, an MU-RTS frame to one or more clients/UEs in the BSS associated with AP 102-4, receiving, at AP 102-4, a CTS frame from one or more clients/UEs in the BSS associated with AP 102-4, and transmitting a CRF from AP 102-4 to AP 102-1. Although particular types of messages or signals (e.g., ICF, MU-RTS, CTS, CRF, etc.) have been described herein, the two-hop carrier sense check may be performed using different types of (short) messages or signals such as RTS or short data followed by CTS, Ack or Block Ack.

The negotiation may require that the signal quality requirements described in 422 and/or 424 be met for the first hop (e.g., the signals sent from AP 102-1 to AP 102-4) and/or the second hop (e.g., signals sent from AP 102-4 to clients/UEs in the BSS). For example, for the first hop, AP 102-1 may indicate that the requirements described with respect to 422 in FIG. 4 be met, and for the second hop, AP 102-1 may indicate that the requirements described with respect to 424 in FIG. 4 (i.e., the MU-RTS being sent at higher MCS level) be met. However, AP 102-1 may indicate that different requirements/conditions should be met for different hops, or one hop has no requirements/conditions.

Referring to FIG. 5, AP 102-1 may transmit ICF 520 to AP 102-4 (the “first hop”). As shown at 522, in some embodiments, AP 102-1 may require that the first hop meets the requirements set forth in 422 of FIG. 4 with respect to the quality at which the ICF 520 is received. As shown at 524, in some embodiments, AP 102-1 may require that the first hop meets the requirements of 424 of FIG. 4. In other words, ICF 520 may be sent at a relatively high MCS level and the signal quality associated with AP 102-4 may be determined based on whether ICF 520 is receivable at AP 102-4.

AP 102-4 may transmit MU-RTS 526 to UE 510-2 and other UEs in the BSS associated with AP 102-4 (the “second hop”). As indicated at 528, if the MU-RTS 526 is received with poor quality (e.g., poor EVM, low SINR, high interference level before, during or after, etc.) at UE 510-2 (and other clients), UE 510-2 (and other clients) may not respond to the MU-RTS. UE 510-2 (and other clients) may respond with CTS 530 if the MU-RTS 526 is received with sufficiently high signal quality. At 532, AP 102-4 may transmit ICR 532 to AP 102-1, which indicates that the signal quality is high enough to make use of the portion of the TXOP.

If AP 102-1 determines that the signal quality at AP 102-4 is sufficiently high, AP 102-1 may determine to grant a portion of the TXOP to AP 102-4. In this case, at 534, AP 102-1 may perform intra-BSS exchanges with UE 510-1 (and possibly other UEs in the BSS) to transmit traffic during a first portion of the TXOP. When AP 102-1 has completed transmitting the traffic, AP 102-1 may transmit MU-RTS frame 536 to allocate the portion of the TXOP. AP 102-4 may respond with a CTS frame 538.

In some embodiments, instead of determining the signal quality at AP 102-4 using ICF 520, MU-RTS 526, CTS 530, and ICR 532, AP 102-1 may determine the signal quality at AP 102-4 using MU-RTS frame 536 and CTS frame 538. For example, after AP 102-1 transmits MU-RTS frame 536 to AP 102-4, AP 102-4 may transmit an MU-RTS frame to UE 510-2 (and other clients), and UE 510-2 (and other clients) may respond with a CTS. AP 102-4 may “transmit” an indication to AP 102-1 that AP 102-4 is in a sufficiently high signal quality environment, where not transmitting CTS frame 538 is an example of an indication.

At 540, AP 102-4 may perform intra-BSS exchanges with UE 510-2 (and possibly other UEs in the BSS) using an unused portion of the TXOP granted by AP 102-1. When the transmission of traffic to UE 510-2 is completed, AP 102-4 may transmit TXOP return frame 542 to return the shared transmission opportunity back to the sharing AP, AP 102-1. In some embodiments, the steps described with respect to MU-RTS frame 536, CTS frame 538, intra-BSS exchanges 540, and TXOP return frame 542 may be repeated with other APs that have requested a portion of the TXOP and who are in a sufficiently high signal quality environment.

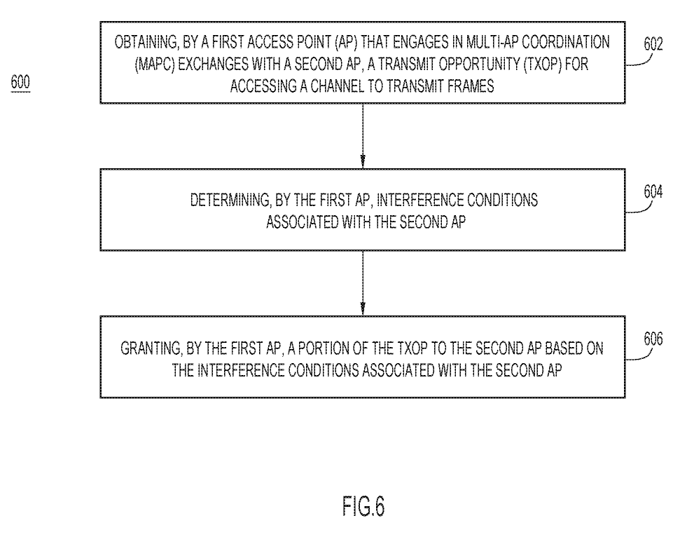

Reference is now made to FIG. 6. FIG. 6 is a flow chart of a method 600 of having a portion of a transmission opportunity granted to an access point based on interference conditions associated with the access point. Reference is also made to FIG. 1 for purposes of the description of FIG. 6.

At 602, method 600 may include obtaining, by a first access point (AP) that engages in Multi-AP Coordination (MAPC) exchanges with a second AP, a transmit opportunity (TXOP) for accessing a channel to transmit frames. For example, AP 102-1 may be granted a TXOP with an exclusive right to transmit and receive traffic to and from devices during a time window. AP 102-1 may engage in MAPC exchanges with a co-channel AP, such as AP 102-4. AP 102-1 and AP 102-4 may have negotiated an agreement for engaging in MAPC exchanges.

At 604, method 600 may include determining, by the first AP, interference conditions associated with the second AP. For example, AP 102-1 may determine interference conditions associated with AP 102-4. In one embodiment, AP 102-1 may determine whether AP 102-4 has a minimum SINR, an adequate EVM, or meets other requirements. In another embodiment, AP 102-1 may determine whether AP 102-4 is able to receive frames sent at a relatively high MCS level or is able to consistently achieve the higher MCS level. In yet other embodiments, AP 102-1 may negotiate that AP 102-4 establishes that it has sufficiently low interference (plus noise) or performs a two-hop carrier sense that meets one or more quality standards as a prerequisite for providing an indication soliciting resources (e.g., a portion of the TXOP or the remainder of the TXOP) from the first AP.

At 606, method 600 may include granting, by the first AP, a portion of the TXOP to the second AP based on the interference conditions associated with the second AP. For example, AP 102-1 may grant a portion or a remainder of the TXOP to AP 102-4 based on determining that the interference conditions of AP 102-4 are below a threshold level. If the interference conditions associated with AP 102-4 are not below the threshold level, AP 102-1 may not grant the portion of the TXOP to AP 102-4.

By determining the interference conditions associated with AP 102-4 (or, in some cases, at the clients of AP 102-4), AP 102-1 may ensure that AP 102-4 is able to make use of the portion/remainder of the TXOP before AP 102-1 grants the portion/remainder of the TXOP to AP 102-4. This increases network efficiency by granting transmission opportunities to access points that can fully make use of the transmission opportunities and prevents access points from wasting transmission opportunities.

In summary, presented herein are techniques by which a first AP, when granting a portion (or the remainder) of its TXOP to a second co-channel AP, is confident that the second AP will make good use of it. In particular, according to the techniques described herein, the first AP may grant the portion of the transmission opportunity to the second AP when the first AP is assured that an interference (or interference plus noise) level at the second AP and/or at the clients of the second AP is sufficiently low.

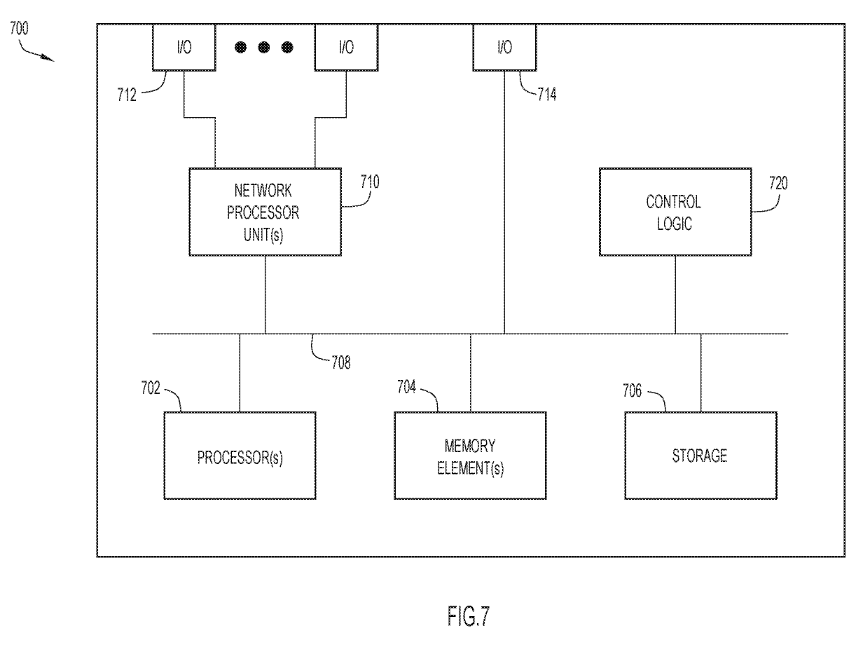

Referring to FIG. 7, FIG. 7 illustrates a hardware block diagram of a device 700 that may perform functions associated with operations discussed herein in connection with the techniques presented herein. In various embodiments, a computing device or apparatus, such as device 700 or any combination of devices 700, may be configured as any entity/entities as discussed for the techniques depicted presented herein in order to perform operations of the various techniques discussed herein. For example, the device 700 may represent an AP or a wireless network controller.

In at least one embodiment, the device 700 may be any apparatus that may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for device 700 can overlap in any manner and are not limited to the specific allocation of instructions and/or operations described herein.

In at least one embodiment, processor(s) 702 is/are at least one hardware processor configured to execute various tasks, operations and/or functions for device 700 as described herein according to software and/or instructions configured for device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 704 and/or storage 706 is/are configured to store data, information, software, and/or instructions associated with device 700, and/or logic configured for memory element(s) 704 and/or storage 706. For example, any logic described herein (e.g., control logic 720) can, in various embodiments, be stored for device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of device 700 to communicate in order to exchange information and/or data. Bus 708 can be implemented with any architecture designed for passing control, data and/or information between processors, memory elements/storage, peripheral devices, and/or any other hardware and/or software components that may be configured for device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/ transmitters/transceivers, baseband processor(s)/modem(s), and/or other similar network interface driver(s) and/or controller(s) now known or hereafter developed to enable communications between device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a method is provided that includes obtaining, by a first access point (AP) that engages in Multi-AP Coordination (MAPC) exchanges with a second AP, a transmit opportunity (TXOP) for accessing a channel to transmit frames; determining, by the first AP, interference conditions associated with the second AP; and granting, by the first AP, a portion of the TXOP to the second AP based on the interference conditions associated with the second AP.

In one example, determining the interference conditions associated with the second AP includes: transmitting, by the first AP to the second AP, a control frame; and obtaining, from the second AP, a response that indicates that the interference conditions are below a threshold level. In another example, determining the interference conditions associated with the second AP includes: transmitting, by the first AP to the second AP, a control frame at a higher than minimum modulation coding scheme (MCS) level; and determining whether the second AP is able to maintain the MCS level based on transmitting the control frame.

In another example, determining whether the second AP is able to maintain the MCS level includes determining that the second AP is unable to maintain the MCS level when the first AP does not receive a response to the control frame. In another example, determining the interference conditions associated with the second AP includes negotiating, by the first AP, that the second AP performs a two-hop carrier sense check with conditions that meet one or more requirements of the first AP.

In another example, performing the two-hop carrier sense check includes: receiving, at the second AP, a first message from the first AP; transmitting, by the second AP, a second message to one or more user devices in a basic service set (BSS) associated with the second AP; receiving, at the second AP, a third message from the one or more user devices; and transmitting, by the second AP, a fourth message to the first AP. In another example, the first message is an initial control frame (ICF), the second message is a Multi-User Request to Send (MU-RTS) message, the third message is a Clear-To-Send (CTS) message, and the fourth message is a control response frame (CRF). In another example, the first AP indicates a minimum modulation coding scheme (MCS) level to be used by the second AP when transmitting the second message to the one or more user devices in the BSS associated with the second AP.

In another form, an apparatus is provided that includes a communication interface; a memory storing instructions; and one or more processors, wherein the one or more processors are configured to execute the instructions to perform operations including: obtaining a transmit opportunity (TXOP) for accessing a channel to transmit frames; determining environmental conditions associated with an access point (AP) that engages in Multi-AP Coordination (MAPC) exchanges with the apparatus; and granting a portion of the TXOP to the AP based on the environmental conditions associated with the AP.

In yet another form, one or more non-transitory computer readable storage media encoded with instructions are provided that, when executed by a processor of a first access point (AP) device, cause the processor to execute a method including: obtaining a transmit opportunity (TXOP) for accessing a channel to transmit frames; determining environmental conditions associated with a second AP device that engages in Multi-AP Coordination (MAPC) exchanges with the first AP device; and granting a portion of the TXOP to the second AP device based on the environmental conditions associated with the second AP device.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by a first access point (AP) that engages in Multi-AP Coordination (MAPC) exchanges with a second AP, a transmit opportunity (TXOP) for accessing a channel to transmit frames;
determining, by the first AP, interference conditions associated with the second AP; and
granting, by the first AP, a portion of the TXOP to the second AP based on the interference conditions associated with the second AP.

2. The method of claim 1, wherein determining the interference conditions associated with the second AP comprises:
transmitting, by the first AP to the second AP, a control frame; and
obtaining, from the second AP, a response that indicates that the interference conditions are below a threshold level.

3. The method of claim 1, wherein determining the interference conditions associated with the second AP comprises:
transmitting, by the first AP to the second AP, a control frame at a higher than minimum modulation coding scheme (MCS) level; and
determining whether the second AP is able to maintain the MCS level based on transmitting the control frame.

4. The method of claim 3, wherein determining whether the second AP is able to maintain the MCS level includes determining that the second AP is unable to maintain the MCS level when the first AP does not receive a response to the control frame.

5. The method of claim 1, wherein determining the interference conditions associated with the second AP comprises negotiating, by the first AP, that the second AP performs a two-hop carrier sense check with conditions that meet one or more requirements of the first AP.

6. The method of claim 5, wherein performing the two-hop carrier sense check comprises:
receiving, at the second AP, a first message from the first AP;
transmitting, by the second AP, a second message to one or more user devices in a basic service set (BSS) associated with the second AP;
receiving, at the second AP, a third message from the one or more user devices; and
transmitting, by the second AP, a fourth message to the first AP.

7. The method of claim 6, wherein the first message is an initial control frame (ICF), the second message is a Multi-User Request to Send (MU-RTS) message, the third message is a Clear-To-Send (CTS) message, and the fourth message is a control response frame (CRF).

8. The method of claim 6, wherein the first AP indicates a minimum modulation coding scheme (MCS) level to be used by the second AP when transmitting the second message to the one or more user devices in the BSS associated with the second AP.

9. An apparatus comprising:
a communication interface;
a memory storing instructions; and
one or more processors, wherein the one or more processors are configured to execute the instructions to perform operations comprising:
obtaining a transmit opportunity (TXOP) for accessing a channel to transmit frames;
determining environmental conditions associated with an access point (AP) that engages in Multi-AP Coordination (MAPC) exchanges with the apparatus; and
granting a portion of the TXOP to the AP based on the environmental conditions associated with the AP.

10. The apparatus of claim 9, wherein the operation of determining the environmental conditions associated with the AP further comprises determining noise and/or interference conditions associated with the AP.

11. The apparatus of claim 9, wherein the operation of determining the environmental conditions associated with the AP comprises:
transmitting a first control frame to the AP; and
obtaining, from the AP, a response that indicates that the environmental conditions are above a threshold quality level.

12. The apparatus of claim 9, wherein the operation of determining the environmental conditions associated with the AP comprises:
transmitting, to the AP, a control frame at a higher than minimum modulation coding scheme (MCS) level; and
determining whether the AP is able to maintain the MCS level based on transmitting the control frame.

13. The apparatus of claim 12, wherein the operation of determining whether the AP is able to maintain the MCS level includes determining that the AP is unable to maintain the MCS level when the apparatus does not receive a response to the control frame.

14. The apparatus of claim 9, wherein the operation of determining the environmental conditions associated with the AP comprises negotiating that the AP performs a two-hop carrier sense check with conditions that meet one or more requirements of the apparatus.

15. The apparatus of claim 14, wherein the operation of performing the two-hop carrier sense check comprises:
receiving, at the AP, a first message from the apparatus;
transmitting, by the AP, a second message to one or more user devices in a basic service set (BSS) associated with the AP;
receiving, at the AP, a third message from the one or more user devices; and
transmitting, by the AP, a fourth message to the apparatus.

16. One or more non-transitory computer readable storage media encoded with instructions that, when executed by a processor of a first access point (AP) device, cause the processor to execute a method comprising:
obtaining a transmit opportunity (TXOP) for accessing a channel to transmit frames;
determining environmental conditions associated with a second AP device that engages in Multi-AP Coordination (MAPC) exchanges with the first AP device; and
granting a portion of the TXOP to the second AP device based on the environmental conditions associated with the second AP device.

17. The one or more non-transitory computer readable storage media of claim 16, wherein determining the environmental conditions associated with the second AP device further comprises determining noise and/or interference conditions associated with the second AP device.

18. The one or more non-transitory computer readable storage media of claim 16, wherein determining the environmental conditions associated with the second AP device comprises:
transmitting, to the second AP device, a control frame; and
obtaining, from the second AP device, a response that indicates that the environmental conditions are above a threshold quality level.

19. The one or more non-transitory computer readable storage media of claim 16, wherein determining the environmental conditions associated with the second AP device comprises:
transmitting, to the second AP device, a control frame at a higher than minimum modulation coding scheme (MCS) level; and
determining whether the second AP device is able to maintain the MCS level based on transmitting the control frame.

20. The one or more non-transitory computer readable storage media of claim 16, wherein determining the environmental conditions associated with the second AP device comprises negotiating that the second AP device performs a two-hop carrier sense check with conditions that meet one or more requirements of the first AP device.
